(19) United States
(12) Patent Application Publication
(10) Pub. No.: US 2017/0292787 A1
(43) Pub. Date: Oct. 12, 2017

(54) SYSTEM AND METHOD FOR DRYING AND SANITIZING A PLURALITY OF DIVERSE ARTICLES

(71) Applicant: GOVERNMENT OF THE UNITED STATES AS REPRESETNED BY THE SECRETARY OF THE AIR FORCE, ROME, NY (US)

(72) Inventors: ROBERT J. DENTON, ROME, NY (US); TIMOTHY H. HUMPHREY, CAMDEN, NY (US)

(21) Appl. No.: 15/181,689

(22) Filed: Jun. 14, 2016

Related U.S. Application Data
(60) Provisional application No. 62/318,789, filed on Apr. 6, 2016.

(51) Int. Cl. F26B 9/00; F26B 21/00; F26B 3/28; A45D 20/12; A47L 23/20; D06F 59/04; F26B 3/02; F26B 21/14

(52) U.S. Cl. CPC F26B 9/003; F26B 3/02; F26B 21/001; F26B 21/14; A45D 20/12; A47L 23/205; F26B 21/003; D06F 59/04; F26B 3/28

(57) ABSTRACT

A highly portable, self-contained, multiple-item drying system that directs an antibacterial warmed air flow stream through a series of separate flexible, expandable, conduits (hoses) to provide an efficient, inexpensive, uncomplicated drying, sanitizing, deodorizing, and heating apparatus.

### PRIORITY CLAIM UNDER 35 U.S.C. §119(e)

This patent application claims the priority benefit of the filing date of provisional application Ser. No. 62/318,789 having been filed in the United States Patent and Trademark Office on Apr. 4, 2016 and now incorporated by reference herein.

### STATEMENT OF GOVERNMENT INTEREST

The invention described herein may be manufactured and used by or for the Government for governmental purposes without the payment of any royalty thereon.

### TECHNICAL FIELD OF THE INVENTION

This invention relates generally to the field of portable drying and sanitizing for is multiple personal articles, such as boots, gloves, and helmets, using an airflow stream that is either ambient temperature or heated, and/or ozone infused.

### BACKGROUND OF THE INVENTION

In order to dry personal equipment and to prevent the problems associated with storing dampened gear, personnel have taken such mundane steps as spreading their damp items out on the floor or hanging them on racks after each use, and then returning them to the container. In more aggressive efforts, they have taken the steps of removing their damp items from their containers, and then use standard or specialized equipment to dry them, and then returning them to the container. There have been numerous blowing and drying devices invented for the purpose of drying shoes, boots, mittens and gloves. For example, see U.S. Pat. No. 4,768,293 issued to Kaffka, U.S. Pat. No. 4,198,765 issued to Miyamae, U.S. Pat. No. 4,145,602 issued to Lee. U.S. Pat. No. 3,645,009 25 issued to Ketchum. U.S. Pat. No. 3,417,482 issued to Peet, U.S. Pat. No. 3,154,392 issued to Littman. U.S. Pat. No. 2,614,337 issued to Darbo, and U.S. Pat. No. 2,443,695 issued to Russell, all of which are discussed in U.S. Pat. No. 5,720,108 issued to Rice. There have also been several specialized bags, devices, or containers developed to dry and sanitize athletic equipment or clothing. Some are small and portable, some are large and stationary, some are hard sided and some are made of flexible material. Of these, some are intended to dry the items while others only sanitize them. Most of these known prior art systems for treating damp or wet items have some common characteristics, but none incorporate all of the characteristics one would desire.

Tactical military activities as well as active athletic sports such as hockey, football, lacrosse, and the like, require specialized equipment and specific clothing for use in completing the mission or playing the game and for protecting the person. Such clothing and equipment items are usually not worn constantly but are transported in some sort of a portable container such as a sports bag or specially container. During vigorous use such clothing and equipment items tend to become damp or wet by either the player's perspiration, or, and also, by being exposed to wet weather or environmental conditions. After an event is completed, if such damp or wet gear is left in a closed container, the gear tends to be acted upon by bacteria and mold, and as a result, becomes foul smelling and rank, and subject to deterioration. Research has shown that such odors are a byproduct of bacteria and mold that grow readily in the moist, dark, generally stagnant, environment inside the closed container. Some of the resulting bacteria may also become a source for infections when they come into contact with an open cut or abrasion on the body of a user the next time the gear is worn. In addition, items left inside a closed container dry so slowly that they may still be wet or damp the next time they are removed from the closed container.

### OBJECTS AND SUMMARY OF THE INVENTION

It is therefore a primary object of the present invention to provide a highly portable, self-contained, multiple-item drying system that directs an anti-bacterial air flow stream through a series of separate flexible, expandable, conduits (hoses) to provide an efficient, inexpensive, uncomplicated drying, sanitizing, deodorizing, and heating apparatus.

A particular object of the invention is provide a drying system that is readily adaptable to a variety of articles.

A further object of the invention is to provide the combined effects of both ultraviolet light and ozone entrained air to ensure antibacterial drying of articles.

Another object of the present invention to provide a drying system that is capable of drawing operating power from a variety of sources.

Other objects and various implementations made possible by this design approach will become apparent in the detailed description of the invention to follow.

In a preferred embodiment of the present invention, a system for drying and sanitizing a plurality of diverse articles, comprises a source of forced air; a plurality of conduits having a first end and a second end for channeling the forced air; a manifold for directing the forced air into the first end of each of the plurality of conduits; an ultraviolet light emitting source located at second end of at least one of the plurality of conduits; and an attachment means located at the second end of at least one of the plurality of conduits for attaching the conduits to the articles so as to direct forced air and ultraviolet light into the articles.

In another embodiment of the present invention, a method for drying and sanitizing a plurality of diverse articles, comprises the steps of generating a stream of forced air; directing the stream of forced air into each of the plurality of articles; warming the forced air prior to directing; and illuminating that portion of each of the plurality of articles onto which said forced air is directed, with ultraviolet light.

Briefly stated, the invention provides a highly portable, self-contained, multiple-item drying system that directs an antibacterial warmed air flow stream through a series of separate flexible, expandable, conduits (hoses) to provide an efficient, inexpensive, uncomplicated drying, sanitizing, deodorizing, and heating apparatus.

### BRIEF DESCRIPTION OF THE DRAWINGS

FIG. 1 is a perspective view of an exemplary embodiment of an individual gear dryer system air blowing assembly and an exemplary manifold with air conduit hoses routed to exemplary individual articles intended for treatment.

FIG. 2 is a perspective view of an exemplary embodiment of an individual gear drying system air blowing assembly.

FIG. 3 is a perspective side view of an exemplary embodiment of an individual gear drying system air blowing assembly showing the intended direction of airflow through the system.

FIG. 4 is a perspective view of an exemplary manifold without air conduit hoses, attached to an exemplary common portable hair drying apparatus.

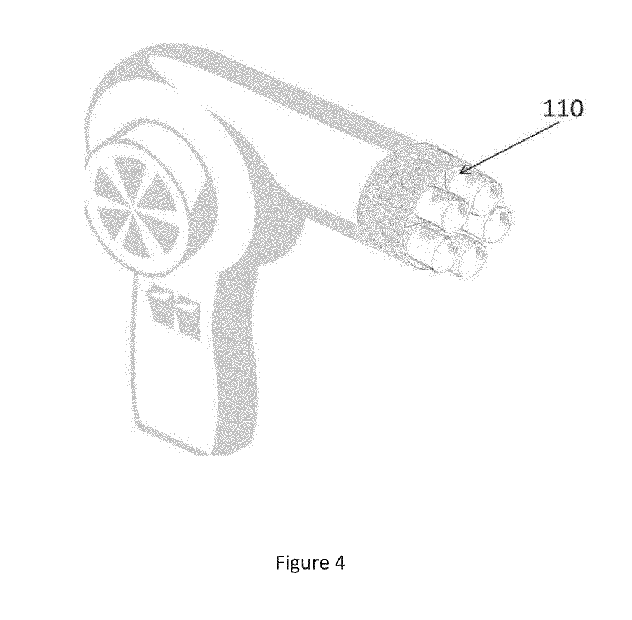

### DETAILED DESCRIPTION OF THE PREFERRED EMBODIMENT

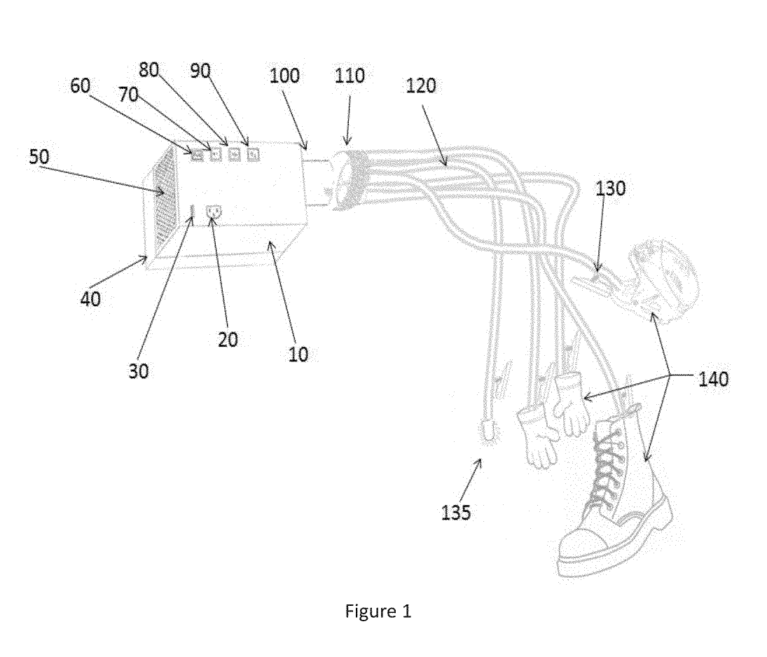

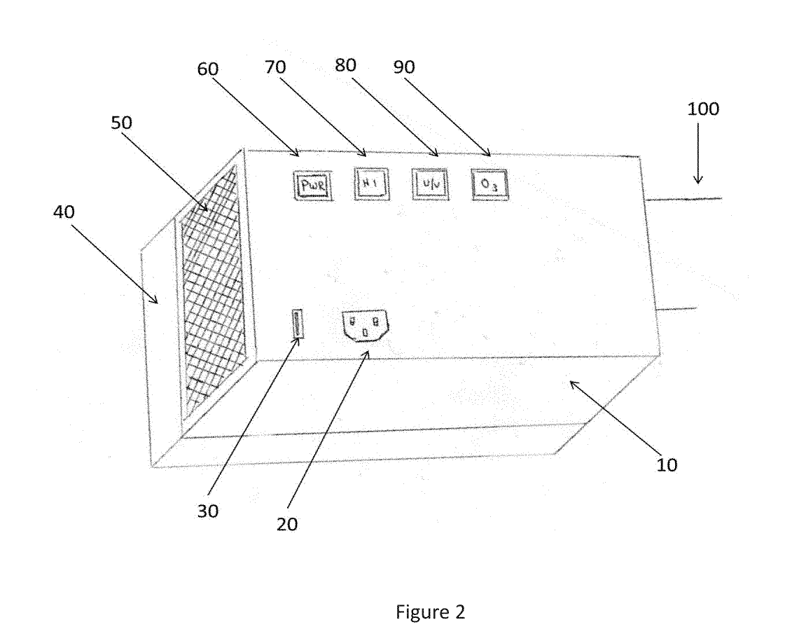

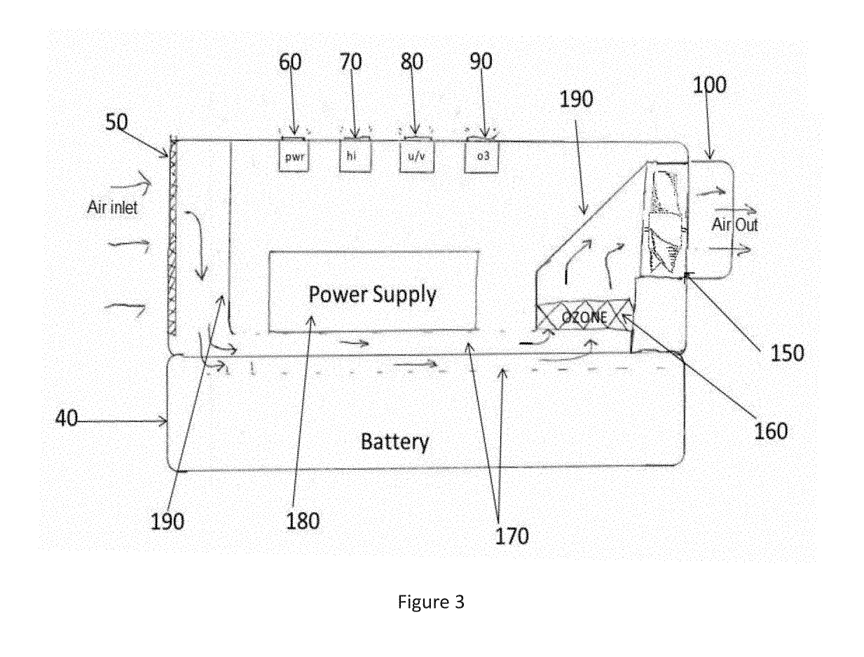

Referring to FIG. 1 and FIG. 2 concurrently, the present invention includes an air blowing assembly 10 consisting of; a housing enclosing an internal fan or blower (see FIG. 3, 150), a rechargeable battery 40, a battery charging power supply (see FIG. 3, 180), an ozone generator (see FIG. 3, 160), the various switches needed for controlling the system 60, 70, 80, 90 and ports 20, 30 for the electrical power required by the system, and a separate attachment consisting of; a manifold 110 with attached hoses 120 and attached to the distal end of the hoses 120, ultraviolet light emitting diodes (UV-LED) for anti-bacterial effect 135, and spring activated clamping clips 130. The housing may be constructed of metal or plastic or other appropriate material.

Referring to FIG. 3, the housing includes an air intake opening 50 which may include a screening or filtering device intended to keep out debris such as vegetation, pollen, sand, and insects. Connected internally to the air intake opening is a plenum 90) that directs the flow of air across and through heat sinks 170 that are associated with the battery 40 and power supply/battery charging system 180, through the anti-bacterial ozone generator 160, through the fan 150 or blower, and out of the housing through a port 100, which has normally attached to it a manifold (see FIG. 1, 110) separating the airflow into five flexible conduit hoses (see FIG. 1, 120).

Still referring to FIG. 3, the invention may be operated with the anti-bacterial ozone generation unit 160 either on or off. The invention includes a rechargeable battery 40 capable of powering the blower 150, the ozone generator 160, and the UV-LED's (see FIG. 1, 135). The invention further includes an (preferably industry standard International Electrical Code (IEC) 60320 C13 type) electrical cord (not shown) and receiving socket (see FIG. 2, 20) enabling the unit to be operated from alternating electrical current as found in common U.S. household electrical outlets, as well as recharging the battery from the same electrical source, or a direct current source such as a solar panel or automotive 12 or 24 volt electrical system. In a preferred embodiment the system power supply 180 electrical input section will be of an automatically sensing and setting type able to detect the input voltage level and frequency and automatically providing the proper output voltage regardless of input type.

Referring again to FIG. 1, Coupled to the housing air outlet port 100 is a five port manifold 110 which connects a plurality (five) of flexible hoses 120 that are intended to direct the flow of output air to item(s) 140 to be dried, warmed and disinfected. The distant end of each hose segment contains a clip 130 which allows it to be fastened to the article to be treated, to prevent the hoses from becoming dislodged, and to direct the end of the hose in a direction which targets the flow of air to a particular location, such as into the toe box of a boot, or inside the fingers of a glove. Each hose also contains a pair of electrical wires encased into and running longitudinally down its length to provide power to an UV-LED for generating anti-bacterial light 135 attached to or embedded into the hose at its distal end. The power to the UV-LEDs 135 can be selected either on or off via a switch 80 mounted upon the system housing 10. The removable manifold 110 is of such a size and circular shape as to allow it to be slid over the end of commonly found, portable, hair dryers, commonly referred to as a blow dryer, enabling the use of the manifold and hose subsystem removed and apart from the subject system air blowing assembly housing 10.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A system for drying and sanitizing a plurality of diverse articles, comprising
a source of forced air;
a plurality of conduits having a first end and a second end for channeling said forced air;
a manifold for directing said forced air into said first end of each of said plurality of conduits;
an ultraviolet light emitting source located at said second end of at least one of said plurality of conduits; and
an attachment means located at said second end of at least one of said plurality of conduits for attaching said conduits to said articles so as to direct said forced air and said ultraviolet light into said articles.

2. The system of claim 1, wherein said source of forced air further comprises a source of ozone.

3. The system of claim 1, wherein said source of forced air further comprises a source of warmed forced air.

4. The system of claim 3, wherein said for drying and sanitizing further comprises power sources consisting of:
a power supply connectable to host power sources; and
a battery;
wherein said power supply and said battery further comprise heatsinks.

5. The system of claim 4, wherein said power supply is a charging source for said battery.

6. The system of claim 4, wherein said source of warmed forced air comprises said forced air subsequent to having been blown across said heatsinks.

7. A method for drying and sanitizing a plurality of diverse articles, comprising the steps of:
generating a stream of forced air;
directing said stream of forced air into each of said plurality of articles;
warming said forced air prior to directing; and
illuminating that portion of each of said plurality of articles onto which said forced air is directed, with ultraviolet light.

8. The method of claim 7, further comprising the step of introducing ozone into said forced air.

9. The method of claim 7, wherein said step of warming said forced air further comprises introducing into said forced air excess heat generated in the production of said forced air.

10. The method claim 7, wherein said step of directing said stream of forced air further comprises channelizing said stream of forced air.

11. The method of claim 10, further comprising securing said channelized stream of forced air to each of said plurality of articles.
